(19) United States
(12) Patent Application Publication
(10) Pub. No.: US 2018/0133739 A1
(43) Pub. Date: May 17, 2018

(54) BATH SHOWER WITH DISPOSABLE FILTRATION UNIT

(71) Applicant: NEP Holdings (Malaysia) Bhd, Selangor (MY)

(72) Inventor: Lim Chang Huat, Selangor (MY)

(73) Assignee: NEP Holdings (Malaysia) Bhd

(21) Appl. No.: 15/349,321

(22) Filed: Nov. 11, 2016

(51) Int. Cl. B05B 15/00; C02F 1/00; C02F 1/48; C02F 1/28; B01D 29/56; B01D 35/02; B05B 1/18; E03C 1/02; E03C 1/04

(52) U.S. Cl. CPC B05B 15/008; C02F 1/001; C02F 1/481; C02F 1/28; C02F 2101/12; B01D 35/02; B05B 1/18; E03C 1/025; E03C 1/0409; B01D 29/56

(57) ABSTRACT

The present invention provides a shower water filter unit (100) to provide clean treated water substantially free from chlorine, organic contaminants, and suspended solids by the use of primary filter (112), secondary filter (114) and tertiary filter (116). The primary filter (112) constructed from polymer type material capable of filtering particles size of 10 microns and above for eliminating suspended solid. The secondary filter (114) made of activated balls for chlorine removal. Tertiary filter (116) made of magnetic ceramics balls and mineral stones reside in elongated, hollow internal chamber of shower head (120) is for water activation.

### FIELD OF INVENTION

The present invention relates to a bath shower unit with disposable filtration unit.

### BACKGROUND OF ART

Municipal water usually contains particles such as excessive chlorine, mud, clay, soil particle and rusty water is conveyed using steel pipes. Untreated water supplies are being polluted by contaminants may result merely in an unpleasant odour or taste in the water or may cause severe consequences such as eyes irritation, skin rashes, and hair damage. Therefore, water filter is used to purify the water and provide safer and raise the quality of the water supply.

One example of shower water filter is disclosed in the U.S. Pat. No. 6,016,977 (US 977 patent) entitled “Hand Held Shower Head and Filter Housing” having a filing date of 29 Jul. 1998 (Applicant: David K. Farley) disclosed a hand held shower head and filter assembly using non-soluble calcium sulfite for filtering contaminants from hot water passing there through at high flow rates. As disclosed in the US 977 patent, the hand held shower head and filter having an elongated, hollow handle. The filter element of the US 977 patent may have a filter media, such as non-soluble calcium sulphite, alone or combined with a copper-zinc medium therein.

Another example of shower water filter is disclosed in the U.S. Pat. No. 6,537,455 (US 455 patent) entitled “Elongated Hand-held Shower Head and Filter” having a grant date of 25 Mar. 2003 (Applicant: David K. Farley) disclosed a combination of hand held shower head and water filter assembly for filtering contaminants from hot water passing there through at high flow rates. It is further provided in the US 455 patent to provide an improved elongated combination hand held shower head and water filter having a swivel shower head attached to an elongated in line hose filter that is sized and dimensioned to it into a holding bracket in two positions.

A further example of shower water filter is disclosed in the U.S. Pat. No. 6,096,197 (US 197 patent) entitled “Shower Filter For Chlorine Removal and Scale Deposit Prevention” having a filing date of 11 Dec. 1997 (Applicant: Douglas E. Hughes) disclosed dual-purpose shower and bath filter to reduce chlorine in shower water through absorption, reduce or eliminate scale deposits. The filter unit enables a single device to simultaneously prevent scale deposits from forming on plumbing and wall surfaces while also reducing or eliminating the chlorine from shower spray. It is further disclosed in US 197 patent that the filter cartridge accomplishes the scale reduction or prevention by treating water with a specially designed phosphate that coats scale (comprising calcium and magnesium) so that it will not stick to plumbing or wall surfaces. Further, the filter cartridge accomplishes the reduction or elimination of chlorine in the water through the absorption capabilities of a superfine mesh powdered activated carbon, formed into a carbon block.

It is the general object of the invention to provide an improved water shower filter unit that effectively removes chlorine, organic contaminants end suspended solid from shower water through multi-layer filter which can further enhance the water quality during bathing and showering.

### SUMMARY OF INVENTION

The present invention relates to a bath shower unit with disposable filtration unit.

One aspect of the invention is to provide a shower water filter unit (100) having a water storage tank (108); a water inlet; a shower head (120); a flexible shower hose member (152, 154, 156) having a first end connected to the storage tank (108) wherein a disposable water filter unit is provided to supply continuous flow of filtered water. The said filter further comprises a primary filter (112); and a secondary filter (114).

Another aspect of the invention provides is to provide a primary filter (112) constructed from polymer type material like filtron.

A further aspect of the invention is to provide a polymer type material which is able to filter particle size of 10 microns and above.

Yet another aspect of the invention is to provide a secondary filter (114) comprises of activated balls to remove chlorine from municipal water supply.

Still another aspect of the invention provides that the said filter further contains tertiary filter (116) made of magnetic ceramics balls and mineral stones.

Yet another aspect of the invention provides that the said shower head (120) is hand held device.

A further aspect of the invention provides that the shower head (120) is connected to the first end of storage tank (108) through said flexible hose.

A further aspect of the invention provides that the shower water filter unit (100) of is used to remove chlorine, organic contaminant and suspended solids.

The present invention consists of features and a combination of parts hereinafter fully described and illustrated in the accompanying drawings, it being understood that various changes in the details may be made without departing from the scope of the invention or sacrificing any of the advantages of the present invention.

### BRIEF DESCRIPTION OF THE ACCOMPANYING DRAWING

To further clarify various aspects of some embodiments of the present invention, a more particular description of the invention will be rendered by references to specific embodiments thereof, which are illustrated in the appended drawings. It is appreciated that these drawings depict only typical embodiments of the invention and are therefore not to be considered limiting of its scope. The invention will be described and explained with additional specificity and detail through the accompanying drawings.

FIG. 1.0 illustrates the exploded perspective view of the shower water filter unit.

### DETAILED DESCRIPTION OF THE PREFERRED EMBODIMENTS

The present invention relates to a bath shower unit with disposable filtration unit. Hereinafter, this specification will describe the present invention according to the preferred embodiments. It is to be understood that limiting the description to the preferred embodiments of the invention is merely to facilitate discussion of the present invention and it is envisioned without departing from the scope of the appended claims.

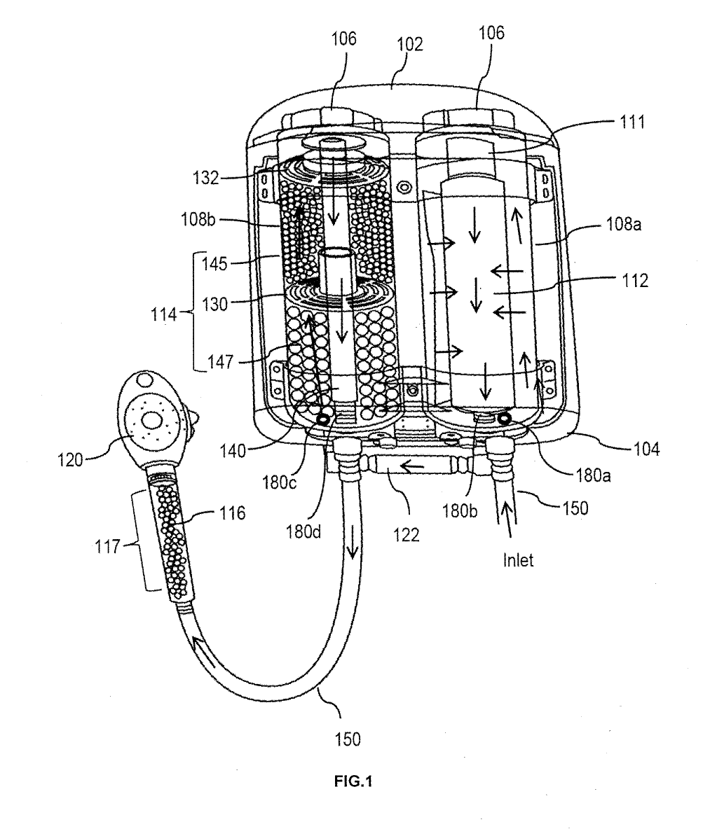

Referring to FIG. 1.0, the main components of the bath shower unit comprise a housing (104), a water storage tank (108), a water inlet, a shower head (120), a flexible shower hose member (152, 154, 156) and disposable water filter unit, which will be described in detail below.

The housing (104) having top cover (102) and interior space for enclosing, a storage tank (108) and directing flow through filtration unit.

The shower head (120) may be constructed in any conventional or known manner from any acceptable material, such as a high strength plastic or the like. The shower head (120) having hollow filter handle with elongated, internal chamber where the tertiary filter (116) held therein. The first end of a flexible hose (152, 154, 156) connected to the shower head and the second end to the storage tank (108)

A water inlet and a water outlet are connected to the water storage tank (108) through a coupling member (122). The water inlet is to let unfiltered water enter the system to receive treatment. The water outlet is for draining the filtered water through the flexible shower hose (108) attached to the shower head (120).

The first stage of filtration is the primary filter (112). The primary filter (112) constructed from polymer type material like Filtron™ high density fabric as the filtration medium (143) which attached to filter holder (111). This fabric is preferred due to its ability to filter off particles size of 10 microns and above. Other filtration medium that can achieve this can also be used instead.

The second stage of filtration is the secondary filter. The secondary filter (114) comprises of multiple layer of activated balls (145, 147) divided by spacer (130) and held filter cartridge (140). The filter cartridge (140) has the end cap (132) and the other end having threaded end. Thus, the filter cartridge (140) may be installed with threaded end in downward position and the end cap (132) in upward position.

The third stage of filtration is the tertiary filter. The tertiary filter (116) contains magnetic ceramics balls and mineral stones held in elongated cylindrical filter cartridge which is aligned to be coaxial with longitudinal axis of the shower head (120) filter handle. A dynamic O-ring (115) is seated in annular grooves in the cartridge neck to facilitate water tight seal. Magnetic ceramics balls and mineral stones of the tertiary filter (116) are used to activate the water. Water that undergoes activation treatment by magnetic field or bio-ceramic stones will transform into smaller clusters of water molecules.

In use, when the water flows from the water inlet, it passes through the primary filter (112) for removal of suspended solid, and then through the secondary filter (114) for removal of chlorine and finally passes through tertiary filter (116) to enhance water quality through water activation before exiting through the shower head (120).

The present embodiments are considered as merely illustrative and not restrictive, the description to the preferred embodiments of the invention is merely to facilitate discussion of the present invention and it is envisioned without departing from the scope of the appended claims.

Unless the context requires otherwise or specifically stated to the contrary, integers, steps or elements of the invention recited herein as singular integers, steps or elements clearly encompass both singular and plural forms of the recited integers, steps or elements.

Throughout this specification, unless the context requires otherwise, the word “comprise”, or variations such as “comprises” or “comprising”, will be understood to imply the inclusion of a stated step or element or integer or group of steps or elements or integers, but not the exclusion of any other step or element or integer or group of steps, elements or integers. Thus, in the context of this specification, the term “comprising” is used in an inclusive sense and thus should be understood as meaning “including principally, but not necessarily solely”.

1. A water shower filter unit having:
at least one water storage tank;
a shower head;
a first flexible hose having a first end connected to a water inlet of a first water storage tank;
a second flexible hose having a first end connected to a water outlet of a second water storage tank and a second end connected to the shower head;
characterized in that the water storage tank further comprises:
a primary filter; and
a secondary filter.

2. The water shower filter unit according to claim 1, wherein the primary filter is preferably constructed from polymer material of high density fabric which includes Filtron™.

3. The water shower filter unit according to claim 1, wherein the polymer material is able to filter particle of 10 microns and above.

4. (canceled)

5. (canceled)

6. The water shower filter unit according to claim 11, wherein the shower head is hand held.

7. (canceled)

8. The water shower filter unit of claim 1, preferably activates water to smaller clusters of water molecules readily absorbed by the human body.

9. The water shower filter unit according to claim 2 wherein the primary filter is disposable.

10. The water shower filter unit according to claim 1, wherein the primary filter comprises of chlorine removal material to remove chlorine and contaminants from a water source.

11. The water shower filter unit according to claim 1, wherein the water shower filter unit is affixed with the shower head having a hollow handle comprises a tertiary filter.

12. The water shower filter unit according to claims 11, wherein the tertiary filter disposed within the hollow handle is made of magnetic energy ceramics balls and mineral stones.
